(19) United States
(12) Patent Application Publication
(10) Pub. No.: US 2009/0276847 A1
(43) Pub. Date: Nov. 5, 2009

(54) Multi-Function Apparatus and Method of Restricting Use of Multi-Function Apparatus

(75) Inventor: Satoshi KOTAKA, Azumino-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/427,593

(22) Filed: Apr. 21, 2009

(30) Foreign Application Priority Data
May 2, 2008 (JP) 2008-120402

(51) Int. Cl. G06F 21/00; G06F 9/00

(52) U.S. Cl. 726/17; 713/100

(57) ABSTRACT

A multi-function apparatus which has plural functions includes: an authentication information acquiring unit which acquires authentication information on a user desiring to use the functions by use of an authentication information inputting unit; a use restriction unit which determines whether the user desiring to use the functions has use authority on the basis of the acquired authentication information, and permits using the functions on condition of determining that the user has the use authority; a mode control unit which acquires operation information formed by the user and transfers a mode of the multi-function apparatus to a basic operation setting mode, when the operation information is accompanied with basic operation setting of the multi-function apparatus; and a log-out control unit which maintains the functions so as to be used by prohibiting a log-out process, when the multi-function apparatus is in the basic operation setting mode at the time of detecting the log-out operation of the user.

### BACKGROUND

1. Technical Field

The invention relates to a multi-function apparatus.

2. Related Art

In the past, as a multi-function apparatus capable of executing plural functions such as an image forming function, an image reading function, and a fax communication function, there was known a multi-function apparatus which has a use restriction function (log-in function) which is based on user authentication so as to permit only qualified users to use the multi-function apparatus in terms of security. This multi-function apparatus includes various units executing a log-in function (such as an authentication device such as a card reader, an interface communicating with an authentication server through a communication network, and a driver for controlling the authentication device and the interface) (for example, see JP-A-2005-335215).

In the multi-function apparatus having this log-in function, the two following methods are used as a control method of executing transfer to an authentication state (a state where use of a restrictive function is permitted) through a predetermined log-in operation of a user and again executing transfer to an authentication standby state (a state where a usable function is restricted).

A first method executes the transfer to the authentication standby state, when a log-out operation is executed by a user. An object of the first method is to take measures for preventing a secret from leaking intentionally by executing a log-out operation when the user completes the use of the multi-function apparatus.

A second method forcedly executes the transfer to the authentication standby state unconditionally, when predetermined time elapses in a state where the user does not operate the multi-function apparatus. An object of the second method is to prevent secret leakage by automatically restricting use of a predetermined function, even when the user forgets to operate the log-out operation after finishing the use of the multi-function apparatus.

When the log-out operation is configured to be executed upon setting a telephone communication line used in fax communication of the multi-function apparatus, setting an IP address used in connection of the multi-function apparatus to a network, and executing change in basic setting of the multi-function apparatus (basic operation setting mode), a problem may occur in that the multi-function apparatus does not temporarily operate. That is because the transfer to the authentication standby state is caused due to an erroneous operation of an operation panel before setting of desired contents is completed.

On the other hand, when a log-out process is configured simply so as not to be permitted in the basic operation setting mode, secret leakage may occur. That is because anyone can use the multi-function apparatus freely, when the user forgets to cancel the basic operation setting mode and goes away from the multi-function apparatus.

### SUMMARY

An advantage of some aspects of the invention is that it provides a multi-function apparatus capable of not permitting a log-out operation of a user in a basic operation setting mode. In addition, another advantage of some aspects of the invention is that it provides a multi-function apparatus capable of executing transfer to an authentication standby state, when predetermined time elapses in a state where an operation panel is not used in a basic operation setting mode.

According to an aspect of the invention, there is provided a multi-function apparatus which has plural functions and includes: an authentication information acquiring unit which acquires authentication information on a user desiring to at least one of use the functions by use of an authentication information inputting unit; a use restriction unit which determines whether the user desiring to at least one of use the functions has use authority on the basis of the acquired authentication information, and permits using the functions on condition of determining that the user has the use authority; a mode control unit which acquires operation information formed by the user and transfers a mode of the multi-function apparatus to a basic operation setting mode, when the operation information is accompanied with basic operation setting of the multi-function apparatus; and a log-out control unit which maintains the functions so as to be used by prohibiting a log-out process, when the multi-function apparatus is in the basic operation setting mode at the time of detecting the log-out operation of the user.

With such a configuration, the log-out operation of the user is not permitted in the basic operation setting mode. Accordingly, it is possible to prevent a problem that the multi-function apparatus does not appropriately operate, since the transfer to the authentication standby state occurs before the desired details are set due to an erroneous operation of the operation panel.

The multi-function apparatus according to this aspect of the invention may further include a timer monitor unit which restricts use of the functions by executing the log-out process, when detecting that predetermined time has elapsed in a state where the user does not execute any operation after the transfer to the basic operation setting mode.

With such a configuration, the transfer to the authentication standby state is forcedly executed, when the predetermined time elapses in a state where the operation panel is not used after the transfer to the basic operation setting mode. Accordingly, it is possible to prevent a problem with secret leakage, even when the user goes away from the multi-function apparatus in the basic operation setting mode.

In the multi-function apparatus according to this aspect of the invention, the mode control unit may cancel the basic operation setting mode, after the basic operation setting is completed by storing setting information in a non-volatile memory. In addition, the transfer to the basic operation setting mode may include an operation of selecting an item of a predetermined menu. With such a configuration, the transfer to and cancellation of the basic operation setting mode can be executed on the basis of a predetermined reference.

According to another aspect of the invention, there is provided a method of restricting use of a multi-function apparatus having plural functions, the method including: acquiring authentication information on a user desiring to use at least one of the functions by use of an authentication information inputting unit; determining whether the user desiring to use at least one of the functions has use authority on the basis of the acquired authentication information, and permitting using the functions on condition of determining that the user has the use authority; acquiring operation information formed by the user and transferring a mode of the multi-function apparatus to a basic operation setting mode, when the operation information is accompanied with basic operation setting of the multi-function apparatus; and maintaining the functions so as to be used by prohibiting a log-out process, when the multi-function apparatus is in the basic operation setting mode at the time of detecting the log-out operation of the user.

The method according to this aspect of the invention can be realized by a CPU included in the multi-function apparatus. However, a program capable of executing the method can be installed or loaded through various media such as a CD-ROM, a magnetic disk, a semiconductor memory, and a communication network.

In the specification, units include units realized by hardware, units realized by software, and units realized by hardware and software. In addition, one unit may be realized by two or more hardware units and two or more units may be realized by one hardware unit.

According to these aspects of the invention, the multi-function apparatus having the log-in function is capable of preventing an unpredictable log-out process in the basic operation setting mode and providing a new technique for flexibly taking a measure when the user forgets executing the log-out operation.

### BRIEF DESCRIPTION OF THE DRAWINGS

The invention will be described with reference to the accompanying drawings, wherein like numbers reference like elements.

FIG. 1 is a block diagram illustrating the overall configuration of an information processing system including a multi-function apparatus.

FIG. 2 is a diagram illustrating a representative function unit of the multi-function apparatus.

FIG. 3 is a flowchart illustrating a process in an authentication standby state of the multi-function apparatus.

FIG. 4 is a flowchart illustrating a process in a log-in state (authentication state) of the multi-function apparatus.

FIG. 5 is a diagram schematically illustrating an example of an operation panel displayed on a basic function menu screen.

### DESCRIPTION OF EXEMPLARY EMBODIMENTS

Hereinafter, an embodiment of the invention will be described in detail with reference to the drawings. The same reference numerals are given to the same constituent elements and repeated description will be omitted.

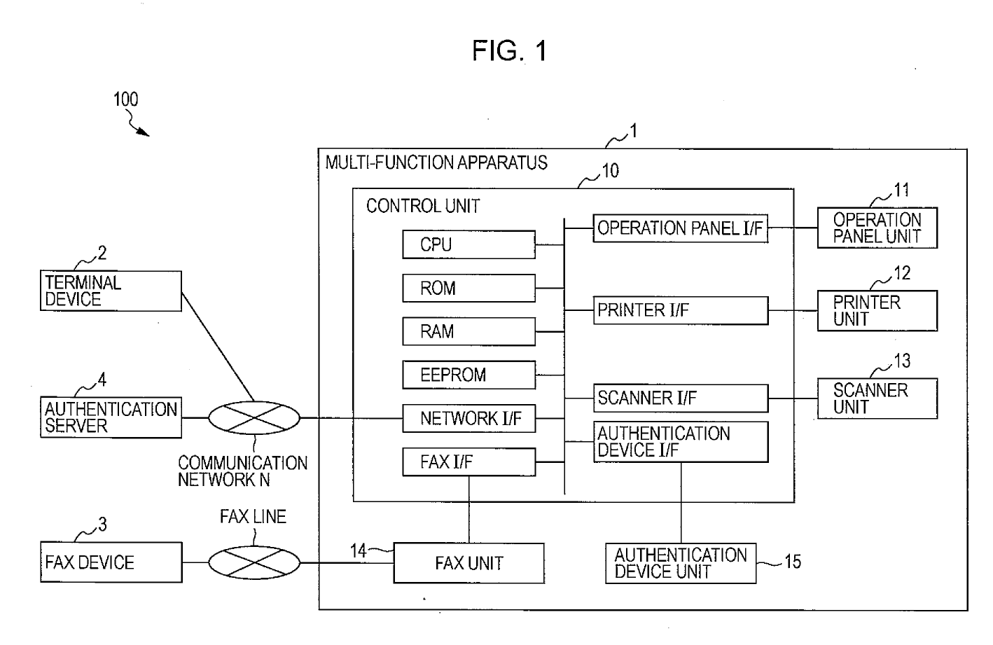

FIG. 1 is a block diagram illustrating the overall configuration of an information processing system 100 including a multi-function apparatus 1 according to an embodiment of the invention.

As shown in FIG. 1, the information process system 100 includes the multi-function apparatus 1, a terminal device 2 which is connected to the multi-function apparatus 1 through the communication network N to transmit a print job to the multi-function apparatus 1, a fax device 3 which is connected to the multi-function apparatus 1 through a fax line to transmit and receive fax data to and from the multi-function apparatus 1, and an authentication server 4 which is connected to the multi-function apparatus 1 through the communication network N to execute an authentication process.

In FIG. 1, one multi-function apparatus 1, one terminal device 2, one fax device 3, one authentication server 4 are illustrated. However, the information processing system 100 may include one or more multi-function peripheries, one or more terminal devices, one or more fax devices, and one or more authentication servers depending on a design thereof. In addition, the communication network N may be configured by an LAN, the Internet, a dedicated line, or a packet communication network or a combination thereof, or by both a wired-line network and a wireless line network.

The multi-function apparatus 1 includes hardware units such as a control unit 10, an operation panel unit 11, a printer unit 12, a scanner unit 13, a fax communication unit 14, and an authentication device unit 15.

The configuration of each hardware unit is the same as that of a known multi-function apparatus in principle. For example, the control unit 10 include a CPU, a memory (a ROM, a RAM, an EEPROM, or the like), an operation panel I/F, a printer I/F, a scanner I/F, a fax I/F, a network I/F, and an authentication device I/F, like a known control unit. As the authentication device unit 15, a card reader unit can be used, for example.

The CPU of the control unit 10 executes programs stored in the memory and controls the hardware units to realize function units of the multi-function apparatus 1.

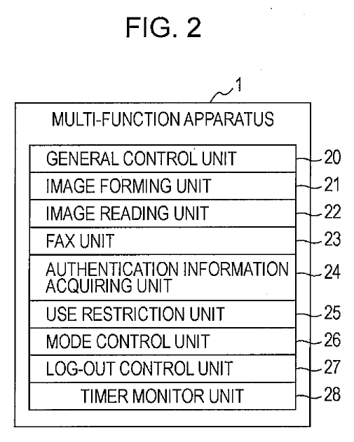

Representative function units of the multi-function apparatus 1 are illustrated in FIG. 2. As shown in FIG. 2, the multi-function apparatus 1 includes a general control unit 20 as a function of controlling the whole operations of the multi-function apparatus 1. As basic functions, function units such as an image forming unit 21, an image reading unit 22 and a fax unit 23 are included.

Like a known multi-function apparatus, the multi-function apparatus 1 includes, as use restriction functions (log-in function) based on the user authentication, an authentication information acquiring unit 24 which acquires authentication information of a user (use desire user) desiring the basic functions of the multi-function apparatus 1 by use of an authentication device unit 15; a use restriction unit 25 which determines whether the use desire user has use authority on the basis of the acquired authentication information and permits the use desire user to use the basic functions on condition that it is determined that the use desire user has the use authority; a mode control unit 26 which acquires operation information of a user through the operation panel unit 11 or the like when the basic functions are permitted to be used (authentication state), and transfers a mode of the multi-function apparatus 1 to a basic operation setting mode when the operation information is accompanied with basic operation setting of the multi-function apparatus; and a log-out control unit 27 which not permits a log-out process and maintains the authentication state, when the multi-function apparatus 1 is in the basic operation setting mode at the time of detecting the log-out operation of the user through the operation panel unit 11 or the like.

The multi-function apparatus 1 also includes a timer monitor unit 28 which executes the log-out process, transfers the authentication state to an authentication standby state, and restricts use of the basic functions, when the timer monitor unit 28 detects that the predetermined time has elapsed in a state where the user does not execute any operation after the transfer to the basic operation setting mode by use of a non-operation monitor timer.

Here, as a use restriction pattern by the use restriction unit 25, it is possible to set (1) a pattern (which is a pattern for allowing the use restriction unit 25 to be valid) used to permit the use of the basic function to only a user succeeding in authentication among direct operation users that directly operate the multi-function apparatus 1 through the operation panel unit 11, (2) a pattern (which is a pattern for allowing the use restriction unit 25 to be partially valid) used to permit the use of the basic functions to a user succeeding in authentication among the direct operation users and to a remote operation user transmitting job information (such as a print job) from an external device such as the terminal device 2 to the multi-function apparatus 1, and (3) a pattern (which is a pattern for allowing the use restriction unit 25 to be invalid) used to permit the use of the basic functions to all users. Information on the set use restriction pattern is stored in a non-volatile memory such as an EEPROM and the stored details are maintained even after the multi-function apparatus 1 is turned off.

The basic operation setting mode is a mode for setting various basic operations of the multi-function apparatus 1 by a general user using the multi-function apparatus 1.

Among setting items for operating the multi-function apparatus 1, the basic operation setting item which can be set in the basic operation setting mode is not a item which is set whenever the multi-function apparatus 1 is turned on or in every print job or every fax job, but a preferable setting item which is maintained even when the multi-function apparatus 1 is turned off and then turned on. Which setting item is set as the basic operation setting item is determined by a manufacturer of the multi-function apparatus or a user. In this embodiment, the basic operation setting item which can be set in the basic operation setting mode of the multi-function apparatus 1 is as follows.

That is, representative examples of the basic operation setting item include a language setting item of displaying a language (such as English or Japanese) on a date/time setting operation panel, a telephone communication line setting item or an IP address setting item for fax connection or network connection, a use restriction pattern setting item for the above-described use restriction pattern, and a server IP address setting item for an authentication server.

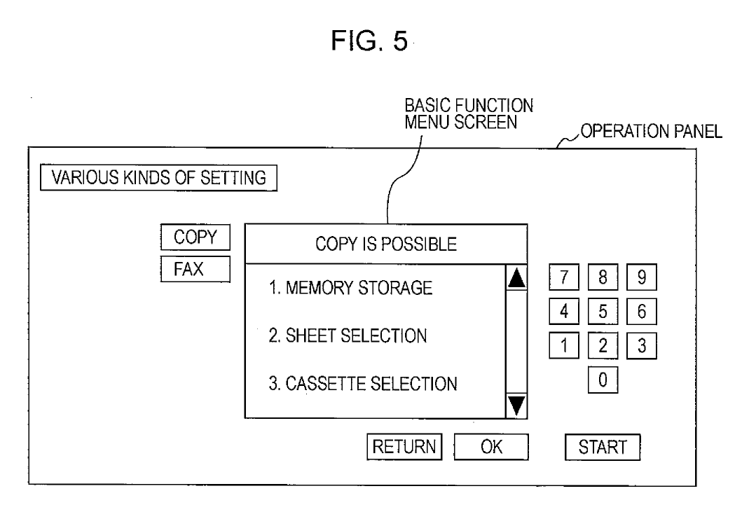

The transfer to the basic operation setting mode by the mode control unit 26 is executed, for example, by detecting an operation of selecting an item regarding to the basic operation setting item from a menu displayed on the screen of the operation panel unit 11 by a user logging in the multi-function apparatus 1 (for example, when an operation of pressing a “various setting” button on a basic function menu screen of the operation panel described below in FIG. 5 by a user is detected). Information on the set basic operation setting item is stored in a non-volatile memory such as an EEPROM and the stored details are maintained even after the multi-function apparatus 1 is turned off.

The transfer to the basic operation setting mode is not limited to the using of the setting menu on the screen or the setting of storing the information in the non-volatile memory such as an EEPROM. An object of the invention is to prevent the log-out when the storing of the basic operation setting information in the EEPROM is executed. However, when setting of preventing the log-out during operation setting is executed, in addition to the setting of storing the information in the EEPROM, for example, when setting information or the like is desired to be temporarily stored in a job memory such as a RAM in setting magnification or setting a sheet feeding unit at the time of using a copy function of the multi-function apparatus, a state where the setting information or the like is tried to be stored in the job memory may be detected as the basic operation setting mode, by raising a flag of the basic operation setting mode when a setting process for the job memory is executed and by lowering the flag after the setting information or the like is stored. For example, in a state where whether to raise the flag of the basic operation setting mode is set in advance as a condition in each button on the operation panel or each operation menu item of an operation screen, a method of determining whether to raise the flag of the basic operation setting mode in accordance with selection of the button or the menu item operated by a user may be used.

The mode control unit 26 detects that the user presses a setting completion button or the like for the basic operation setting item and cancels the basic operation setting mode, when the user operates to come out of the basic operation setting mode or when the flag of the basic operation setting mode is not raised.

In the non-operation monitor timer referred by the timer monitor unit 28, count of a timer is activated when the user finally operates the operational panel or the like in order to measure elapsed time in which the operation panel or the like of the multi-function apparatus 1 is not used.

The terminal device 2, the fax device 3, and the authentication server 4 included in the information processing system 100 all have the same configuration and functions as those of a known example. For example, the authentication server 4 has a function of executing an authentication process on the basis of an authentication request transmitted from the multi-function apparatus 1 and replying information on success or failure of the authentication as a result of the authentication process to the multi-function apparatus 1.

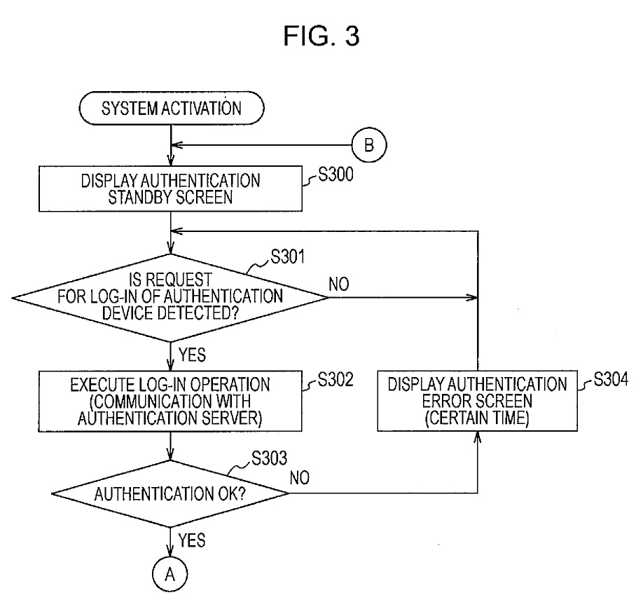

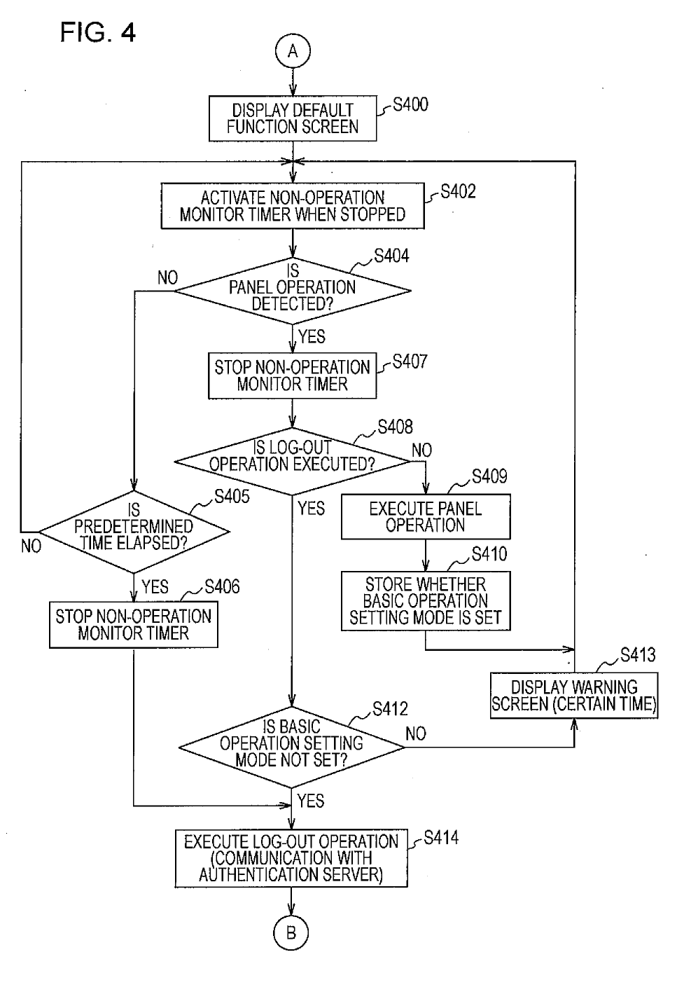

Hereinafter, various processes of the multi-function apparatus 1 will be described with reference to the flowcharts shown in FIGS. 3 and 4. In the specification, the processes (including partial processes to which reference numerals are not given) shown in the flowcharts may be arbitrarily changed in sequence or executed in a parallel manner to the extent that the processes are not contradictory to each other.

### Authentication Standby Process

The flowchart in FIG. 3 shows an authentication standby process in the multi-function apparatus 1.

The general control unit 20 displays a log-in standby screen on a display unit of the operation panel unit 11 (S300).

The authentication information acquiring unit 24 waits an operation of inputting the authentication information to the authentication device unit 15 by the use desire user (S301). When certain time elapses in a state where the authentication information is not input (No in S301), the process returns to S301.

Alternatively, when the operation of inputting the authentication information to the authentication device unit 15 (Yes in S301), the authentication information acquiring unit 24 acquires the authentication information of the use desire user through the authentication device unit 15. Subsequently, the use restriction unit 25 generates an authentication request including the acquired authentication information and transmits the authentication request to the authentication server 4 (S302).

Like a known example, when the authentication server 4 receives the authentication request transmitted from the multi-function apparatus 1, the authentication server 4 executes the authentication process on the basis of the authentication request and replies information on authentication success or failure as a result of the authentication process to the multi-function apparatus 1. When the authentication succeeds, the fact that a user corresponding to the authentication information logs in the multi-function apparatus 1 is recorded and managed.

When the use restriction unit 25 receives the information on authentication success or failure as a reply to the authentication request from the authentication server 4, the use restriction unit 25 determines whether the use desire user has the use authority on the basis of the information on authentication success or failure (S303).

When the information on authentication success or failure represents authentication failure (No in S303), the use restrict unit 25 determines that the use desire user does not have the use authority and does not permit the use of the basic functions of the multi-function apparatus 1 to the use desire user. Specifically, a message representing the authentication fails is displayed by repeatedly displaying a new screen (an authentication error display screen) on the authentication standby screen of the display unit of the operation panel unit 11 (S304). After certain time elapses, the authentication error display screen is deleted. Then, the process returns to S301.

Alternatively, when the information on authentication success or failure represents authentication success (Yes in S303), the use restriction unit 25 determines that the use desire user has the use authority and permits the use of the basic functions of the multi-function apparatus 1 to the use desire user. Specifically, use restriction unit 25 records information representing the fact that the use desire user logs in the multi-function apparatus 1 in the memory of the multi-function apparatus 1 and allows the process to proceed to a log-in process.

### Log-In (Authentication) Process

The flowchart in FIG. 4 shows the log-in (authentication) process in the multi-function apparatus 1.

In the log-in process, the general control unit 20 displays a basic function menu screen for selecting the basic functions on the display unit of the operation panel unit 11 (S400). Subsequently, the timer monitor unit 28 activates the non-operation monitor timer when the non-operation monitor timer for monitoring timeout stops (S402) and waits a panel operation of the use desire user (S404).

FIG. 5 schematically shows an example of the operation panel displayed on the basic function menu screen in S400. In addition, the fact (the fact that the use desire user logs in) at the time of the authentication success may be configured to be expressed by a display of the display unit or a lamp of the operation panel.

When the panel operation of the use desire user is not detected in S404 (No in S404), the timer monitor unit 28 determines whether predetermined time elapses after the activation of the non-operation monitor timer with reference to the non-operation monitor timer (S405).

Here, when the predetermined time does not elapse (No in S405), the process is controlled so as to return to S402 and a panel operation of the use desire user is waited. Alternatively, when the predetermined time elapses (Yes in S405), the timer monitor unit 28 determines that the predetermined time expires and execute a timeout process. That is, the timer monitor unit 28 stops the process (S406) and transfers to a log-out process in S414 described below.

Alternatively, when the panel operation of the use desire user is detected in S404 (Yes in S404), the timer monitor unit 28 stops the non-operation monitor timer (S407) and the general control unit 20 determines whether the panel operation detected in S404 is the log-out operation (S408).

When the panel operation is not the log-out operation (No in S408), the general control unit 20 executes a process associated with the detected panel operation by controlling each unit (S409), like a known example. At this time, the mode control unit 26 determines whether the operation information is accompanied with the basic operation setting of the multi-function apparatus on the basis of information on the panel operation detected in S404. When the operation information is accompanied with the basic operation setting, the mode of the multi-function apparatus 1 is transferred to the basic operation setting mode (S410). Then, the process returns to S402.

Alternatively, when the panel operation is the log-out operation (Yes in S408), the log-out control unit 27 confirms a state of the multi-function apparatus 1 and determines whether the mode thereof is the basic mode setting mode (S412). When the basic operation setting mode is set (No in S412), the log-out control unit 27 determines that the operation is the log-out operation executed erroneously in the basic operation setting mode and executes control so as not to log out from the authentication state to the authentication standby state, that is, so as to ignore the log-out operation of the use desire user. Specifically, the user is notified by displaying a warning screen expressing the log-out from the basic operation setting mode on the display unit of the operation panel unit 11 or making a warning sound (S413). After certain time elapses, the process returns to S402.

Alternatively, when the basic operation setting mode is not set (Yes in S412), the log-out control unit 27 records information indicating that the use desire user has logged out the multi-function apparatus 1 in the memory of the multi-function apparatus 1 and generates a log-out message including the authentication information of the use desire user to transmit the authentication information to the authentication server 4 (S414). Then, the process of the multi-function apparatus 1 proceeds to S300.

Like a known example, when the authentication server 4 receives the log-out message transmitted from the multi-function apparatus 1, the authentication server 4 records and manages the fact that the user corresponding to the authentication information contained in the log-out message logs out the multi-function apparatus 1.

In this way, in the multi-function apparatus 1 according to this embodiment, the log-out operation is not permitted when the user changes the setting of the basic operation or the like in the basic operation setting mode, and the forced transfer to the authentication standby state can be executed even in the basic operation setting mode by forcedly executing the log-out process when the predetermined time elapses without the panel operation.

### MODIFIED EXAMPLES

The invention is not limited to the above-described embodiment, but may be modified in various forms within the scope of the invention without departing the gist of the invention. Accordingly, the above-described embodiment is just an example in terms of all aspects and is not interpreted as a restricted example. For example, in the above-described embodiment, the multi-function apparatus has the image forming function, the image reading function, and the fax communication function as the basic functions. However, the invention is not limited to the multi-function apparatus having these basic functions. For example, even when the multi-function apparatus does not have one or two of the image reading function and the fax communication function, the invention can be applied to a multi-function apparatus having a printing function. In addition, the invention can be applied to a multi-function apparatus having basic functions other than the above basic functions.

In the above-described embodiment, as the operation for the transfer to the setting change mode, the operation of pressing the “various setting” button provided in the operation panel unit 11 is used. However, as the operation for the transfer to the setting change mode, an operation executed only by an administrator may be used. Moreover, an operation of pressing the “various setting” button provided in the operation panel unit 11 and a subsequent operation of inputting an administrator password may be used together, and an arbitrary operation may be used depending on a design. For example, an operation of selecting an option representing the transfer to the setting change mode and displayed on the display unit and a subsequent operation of inputting an administrator password may be used as the operation for the transfer to the setting change mode.

In the above-described embodiment, the use restriction unit 25 is configured to determine whether the use desire user has the use authority on the basis of the authentication result of the authentication server 4. However, the password of a qualified user is stored in advance in a non-volatile memory of the multi-function apparatus 1 and the use restriction unit 25 may determine whether the use desire user has the use authority (whether the use desire user is the qualified user) by comparing the stored password of the qualified user to a password input from the use desire user through the operation panel unit 11.

The entire disclosure of Japanese Patent Application No. 2008-120402, filed May 2, 2008 is expressly incorporated by reference herein.

What is claimed is:

1. A multi-function apparatus which has plural functions, comprising:
an authentication information acquiring unit which acquires authentication information on a user desiring to use at least one of the functions by use of an authentication information inputting unit;
a use restriction unit which determines whether the user desiring to use at least one of the functions has use authority on the basis of the acquired authentication information, and permits using the functions on condition of determining that the user has the use authority;
a mode control unit which acquires operation information formed by the user and transfers a mode of the multi-function apparatus to a basic operation setting mode, when the operation information is accompanied with basic operation setting of the multi-function apparatus; and
a log-out control unit which maintains the functions so as to be used by prohibiting a log-out process, when the multi-function apparatus is in the basic operation setting mode at the time of detecting the log-out operation of the user.

2. The multi-function apparatus according to claim 1, further comprising a timer monitor unit which restricts use of the functions by executing the log-out process, when detecting that predetermined time has elapsed in a state where the user does not execute any operation after the transfer to the basic operation setting mode.

3. The multi-function apparatus according to claim 1, where the mode control unit cancels the basic operation setting mode, after the basic operation setting is completed by storing setting information in a non-volatile memory.

4. The multi-function apparatus according to claim 1, where the transfer to the basic operation setting mode includes an operation of selecting an item of a predetermined menu.

5. A method of restricting use of a multi-function apparatus having plural functions, the method comprising:
acquiring authentication information on a user desiring to use at least one of the functions by use of an authentication information inputting unit;
determining whether the user desiring to use at least one of the functions has use authority on the basis of the acquired authentication information, and permitting using the functions on condition of determining that the user has the use authority;
acquiring operation information formed by the user and transferring a mode of the multi-function apparatus to a basic operation setting mode, when the operation information is accompanied with basic operation setting of the multi-function apparatus; and
maintaining the functions so as to be used by prohibiting a log-out process, when the multi-function apparatus is in the basic operation setting mode at the time of detecting the log-out operation of the user.

6. A recording medium recorded a program causing a computer to execute the method according to claim 5.
